(19) United States
(12) Patent Application Publication
(10) Pub. No.: US 2011/0148750 A1
(43) Pub. Date: Jun. 23, 2011

(54) MOBILE DEVICE ELECTRONIC INK DISPLAY PRESERVING CRITICAL DATA

(76) Inventor: Miriam Ayala, Kew Garden Hills, NY (US)

(21) Appl. No.: 12/640,274

(22) Filed: Dec. 17, 2009

(51) Int. Cl. G09G 3/34

(52) U.S. Cl. 345/107

(57) ABSTRACT

The present disclosure relates to mobile devices with e-ink (electronic ink) displays configured to preserve and display critical data, such as responsive to loss of power. The mobile devices may include cell phones, smart phones, pagers, PDAs, and the like, and the mobile devices are equipped with an e-ink or e-paper technology type display. The mobile device is configured to write out critical data to the display upon Critical Battery notification or upon other criteria. In an exemplary embodiment, a mobile device includes memory; input/output interfaces; a processor; an electronic ink display; and an interface communicatively coupling the memory, the input/output interfaces, the processor, and the electronic ink display; wherein the electronic ink display is configured to display data responsive to predetermined criteria.

### FIELD OF THE INVENTION

The present disclosure relates to mobile devices and more particularly to mobile devices with e-ink (electronic ink) displays configured to preserve and display critical data, such as responsive to loss of power.

### BACKGROUND OF THE INVENTION

Increasingly portable, wireless, mobile computing devices have become widespread with almost everyone carrying such devices on a regular basis. Exemplary mobile devices may include cell phones, smart phones, pagers, personal data accessories (PDA), and the like. In particular, when a mobile computing device loses its main battery power, critical information that is stored on the mobile computing device is no longer accessible without replacing the battery or applying external power. To a mobile user this can be detrimental. For example, the airline industry is now enabling customers to use their mobile computing devices to display their boarding cards on the display of the device as proof of bearing a boarding card as opposed to the traditional ticketing mechanism. The device may display a barcode that the agent then scans. If the battery on the device goes dead, a traveler may be stuck.

### BRIEF SUMMARY OF THE INVENTION

In an exemplary embodiment of the present invention, a mobile device includes memory; input/output interfaces; a processor; an electronic ink display; and an interface communicatively coupling the memory, the input/output interfaces, the processor, and the electronic ink display; wherein the electronic ink display is configured to display data responsive to predetermined criteria. The mobile device may further include a wireless network interface communicatively coupled to the memory, the input/output interfaces, the processor, and the electronic ink display through the interface. The mobile device may further include a housing in which each of the wireless network interface, the memory, the input/output interfaces, the processor, and the electronic ink display are disposed. Optionally, the electronic ink display may be disposed on the housing separate from a display associated with the input/output interfaces. Alternatively, the electronic ink display may be disposed on the housing separate overlaid on a display associated with the input/output interfaces. The data may include one of a reference code number and a location code number. The data may include a scan-able code, and the scan-able code may include a bar code associated with ticketing. The data may include a map or directions. The processor may be configured to: receive input from a user; identify data for display on the electronic ink display; determine an occurrence of the predetermined criteria; and direct the electronic ink display to display the data based on the occurrence. The predetermined criteria may include at least one of loss of power for the mobile device, low battery, and a user-defined occurrence. The processor may be further configured to: receive owner information from a user; and responsive to turning the mobile device off, display the owner information on the electronic ink display. Alternatively, the processor may be configured to: responsive to low battery, turn off the mobile device; provide a user interface through the electronic ink display; and provide limited access to the memory through the electronic ink display. The processor may be further configured to: provide a graphical user interface to a user; identify data through the graphical user interface for display on the electronic ink display; identify through the graphical user interface the predetermined criteria for displaying the data on the electronic ink display; determine an occurrence of the predetermined criteria; and direct the electronic ink display to display the data based on the occurrence. The electronic ink display may include any of Gyricon, electrophoretic, Electro-wetting, Electrofluidic, cholesteric liquid crystal, Nemoptic and Nematic materials.

In another exemplary embodiment of the present invention, an electronic display on a mobile device include a low power electronic ink display disposed on a housing of the mobile device; and an activation mechanism coupled to the low power electronic ink display for displaying predetermined data on the low power electronic ink display upon an occurrence of predetermined criteria. In yet another exemplary embodiment of the present invention, a method includes providing a device with a low-power electronic display; identifying critical data; operating the device; and responsive to an occurrence of a criteria event, displaying the critical data on the low-power electronic display. The device may include a mobile device and the low-power electronic display may include one of electronic ink or electronic paper configured to operate when the mobile device has low battery power. The method may further include, responsive to powering off the device, displaying owner information identifying the owner of the device on the low-power electronic display.

### BRIEF DESCRIPTION OF THE DRAWINGS

The present invention is illustrated and described herein with reference to the various drawings of exemplary embodiments, in which like reference numbers denote like method steps and/or system components, respectively, and in which:

FIG. 1 is a block diagram of a mobile device with an electronic ink display for preserving and displaying critical according to an exemplary embodiment of the present invention;

FIG. 2 is a perspective diagram of a mobile device with an electronic ink display for preserving and displaying critical according to an exemplary embodiment of the present invention; and

FIG. 3 is a flowchart of a method for preserving and displaying critical data with a mobile device according to an exemplary embodiment of the present invention.

### DETAILED DESCRIPTION OF THE INVENTION

In various exemplary embodiments, the present invention relates to mobile devices with e-ink (electronic ink) displays configured to preserve and display critical data, such as responsive to loss of power. The mobile devices may include cell phones, smart phones, pagers, PDAs, and the like, and the mobile devices are equipped with an e-ink or e-paper technology type display. The mobile device is configured to write out critical data to the display upon Critical Battery notification or upon other criteria. In an exemplary embodiment, a mobile device includes memory; input/output interfaces; a processor; an electronic ink display; and an interface communicatively coupling the memory, the input/output interfaces, the processor, and the electronic ink display; wherein the electronic ink display is configured to display data responsive to predetermined criteria. In another exemplary embodiment, an electronic display on a mobile device includes a low power electronic ink display disposed on a housing of the mobile device; and an activation mechanism coupled to the low power electronic ink display for displaying predetermined data on the low power electronic ink display upon an occurrence of predetermined criteria.

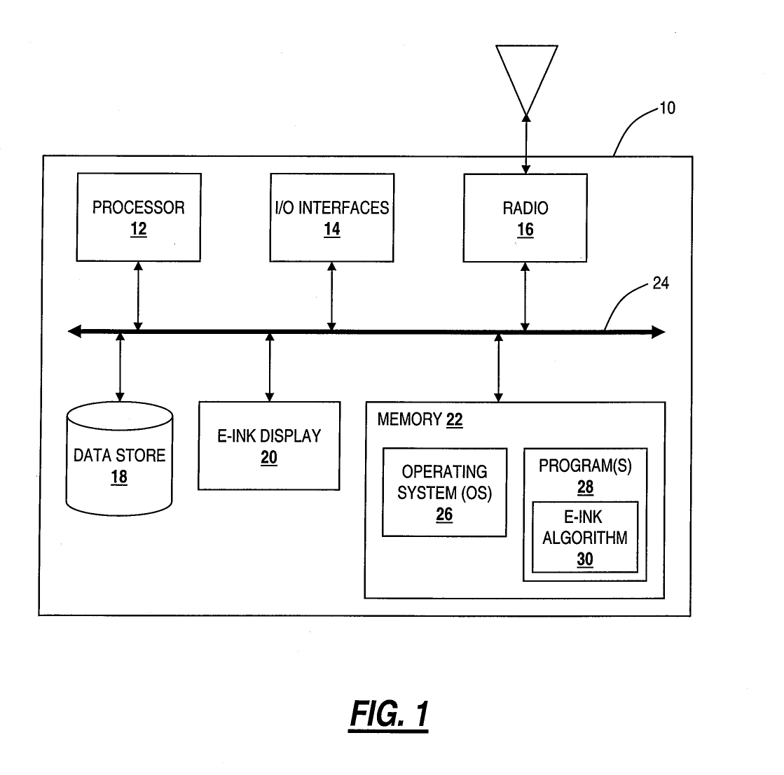

Referring to FIG. 1, in an exemplary embodiment, the present invention includes a mobile device 10 with various components for preserving and displaying critical data. The mobile device 10 can be a digital device that, in terms of hardware architecture, generally includes a processor 12, input/output (I/O) interfaces 14, a radio 16, a data store 18, an accelerometer 20, and memory 22. It should be appreciated by those of ordinary skill in the art that FIG. 1 depicts the mobile device 10 in an oversimplified manner, and a practical embodiment may include additional components and suitably configured processing logic to support known or conventional operating features that are not described in detail herein. The components (12, 14, 16, 18, 20, and 22) are communicatively coupled via a local interface 24. The local interface 24 can be, for example but not limited to, one or more buses or other wired or wireless connections, as is known in the art. The local interface 24 can have additional elements, which are omitted for simplicity, such as controllers, buffers (caches), drivers, repeaters, and receivers, among many others, to enable communications. Further, the local interface 24 can include address, control, and/or data connections to enable appropriate communications among the aforementioned components.

The processor 12 is a hardware device for executing software instructions. The processor 12 can be any custom made or commercially available processor, a central processing unit (CPU), an auxiliary processor among several processors associated with the mobile device 10, a semiconductor-based microprocessor (in the form of a microchip or chip set), or generally any device for executing software instructions. When the mobile device 10 is in operation, the processor 12 is configured to execute software stored within the memory 22, to communicate data to and from the memory 22, and to generally control operations of the mobile device 10 pursuant to the software instructions. The I/O interfaces 14 can be used to receive user input from and/or for providing system output to one or more devices or components. User input can be provided via, for example, a keyboard, a keypad, a touch screen, a mouse, a scroll bar, buttons, bar code scanner, and the like. System output can be provided via a display device such as a liquid crystal display (LCD), touch screen, and the like. The I/O interfaces 14 can also include, for example, a serial port, a parallel port, a small computer system interface (SCSI), an infrared (IR) interface, a radio frequency (RF) interface, and/or a universal serial bus (USB) interface. The I/O interfaces 14 can include a graphical user interface (GUI) that enables a user to interact with the mobile device 10. Additionally, the I/O interfaces 14 can further include an imaging device, i.e. camera, video camera, etc., referred to herein collectively as an imager. The imager is configured to provide pictures and/or video to the device 10 from a camera lens disposed in the device 10.

The radio 16 enables wireless communication to an external access device or network. Any number of suitable wireless data communication protocols, techniques, or methodologies can be supported by the radio 16, including, without limitation: radio frequency (RF); IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and the like. The data store 18 can be used to store data. The data store 18 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 18 can incorporate electronic, magnetic, optical, and/or other types of storage media.

The memory 22 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 22 may incorporate electronic, magnetic, optical, and/or other types of storage media. Note that the memory 22 can have a distributed architecture, where various components are situated remotely from one another, but can be accessed by the processor 12. The software in memory 22 can include one or more software programs, each of which includes an ordered listing of executable instructions for implementing logical functions. In the example of FIG. 1, the software in the memory system 22 includes a suitable operating system (O/S) 26 and programs 28. The operating system 26 essentially controls the execution of other computer programs, and provides scheduling, input-output control, file and data management, memory management, and communication control and related services. The operating system 26 can be any of LINUX (or another UNIX variant), Android (available from Google), Symbian OS, Microsoft Windows CE, iPhone OS (available from Apple, Inc.), Palm OS, Blackberry OS, and the like. The programs 28 can include a program configured to interact with an E-ink display 20 for preserving and displaying critical data upon the occurrence of various events including loss of power.

The mobile device 10 further includes the E-ink display 20 for displaying data. The E-display 20 may include E-ink (from the E Ink Corporation) or other variants of electronic paper. Of note, the E-ink display 20 requires extremely low power thereby making it ideal for displaying data when faced with power issues. Unlike a conventional flat panel display, which uses a backlight to illuminate its pixels, the E-ink display 20 reflects light like ordinary paper and is capable of holding text and images indefinitely without drawing electricity, while allowing the image to be changed later. The E-ink display 20 may be implemented with various different technologies such as Gyricon, electrophoretic, Electro-wetting, Electrofluidic, cholesteric liquid crystal, Nemoptic and Nematic materials, and the like. An electrophoretic display is an information display that forms visible images by rearranging charged pigment particles using an applied electric field. The electrophoretic display may use tiny microcapsules filled with electrically charged white particles suspended in a colored oil. The microcapsules may be held in a layer of liquid polymer, sandwiched between two arrays of electrodes, the upper of which is made transparent. The two arrays are aligned so that the sheet is divided into pixels, which each pixel corresponding to a pair of electrodes situated either side of the sheet. The sheet may be laminated with transparent plastic for protection, resulting in an overall thickness of 80 micrometers, or twice that of ordinary paper. The network of electrodes is connected to display circuitry, which turns the electronic ink ‘on’ and ‘off’ at specific pixels by applying a voltage to specific pairs of electrodes. Applying a negative charge to the surface electrode repels the particles to the bottom of local capsules, forcing the black dye to the surface and giving the pixel a black appearance. Reversing the voltage has the opposite effect—the particles are forced from the surface, giving the pixel a white appearance. A more recent incarnation of this concept requires only one layer of electrodes beneath the microcapsules. As described herein, the E-ink display 20 may utilize any electronic paper or electronic ink technologies.

In an exemplary embodiment, the E-ink display 20 may be integrated with another display (i.e. part of the I/O interfaces 14). Here, the mobile device 10 may include a combined E-ink and LCD. Alternatively, the E-ink display 20 may be a separate display disposed on a housing of the mobile device 10. As described herein, the E-ink display 20 is configured to display certain data upon the occurrence of various events. The programs 28 can include a software E-ink algorithm 30 that interacts with the E-ink display 20 to display data. For example, the E-ink algorithm 30 may be configured to write our critical data to the E-ink display 20 upon Critical Battery notification. The software E-ink algorithm 30 may, for example, display on the e-ink display 20 a reference code number, locator number, map and directions, telephone numbers, or any other data. Alternatively, the software E-ink algorithm 30 can write out a bar code to the E-ink display 20. Here, a ticketing agent would be able to scan the barcode on the e-ink display to validate information associated with the user.

The E-ink algorithm 30 may be further configured to determine what data is displayed and when the data is displayed. For example, the E-ink algorithm 30 may include a user interface displayed on the LCD or the like in the I/O interfaces 14 that allows a user to determine the displayed data on the E-ink display 20. Also, the user interface may include various configurable settings whereby the E-ink display 20 displays the data. For example, these settings may include low power, specified time, based on a user command, and the like.

In an exemplary embodiment, the mobile device 10 may be used with the E-ink display 20 for displaying ticketing information. Here, a user may utilize the mobile device 10 to access a ticketing system, such as through a web browser in the mobile device 10, through an email, etc. The ticketing system may provide a boarding pass with a bar code or some other scan-able image. The user may direct the E-ink algorithm 30 that the boarding pass is the critical data for display on the E-ink display 20. Alternatively, the mobile device 10 may directly import the boarding pass into the E-ink algorithm 30 automatically. In addition to ticketing information, other examples of data displayable on the E-ink display 20 may include owner information of the mobile device 10 including name, phone number, email address, etc.; map and direction information; reward card information such as with grocery stores, pharmacies, and other retail stores; and the like. In another exemplary embodiment, the E-ink display 20 may be configured to display the owner information whenever the mobile device 10 is turned off or loses power. This may be useful in case the mobile device 10 is lost or misplaced.

In another exemplary embodiment, the E-ink algorithm 30 may be configured to enable access to the data store 18 and/or the memory 22 of the mobile device 10 for limited purposes of obtaining and displaying data. For example, the E-ink algorithm 30 may be configured to operate with extremely low power to access data in the data store 18 and/or the memory 22, such as a particular email, boarding pass, contact name, etc. Here, the E-ink algorithm 30 may be configured to display a user interface and allow input keys to operate to access and display data on the E-ink display 20. Also, such functionality may be used in an “airplane” mode where the E-ink display 20 is used to display data while the mobile device 10 is off. This may include emails, ebook readers, and the like.

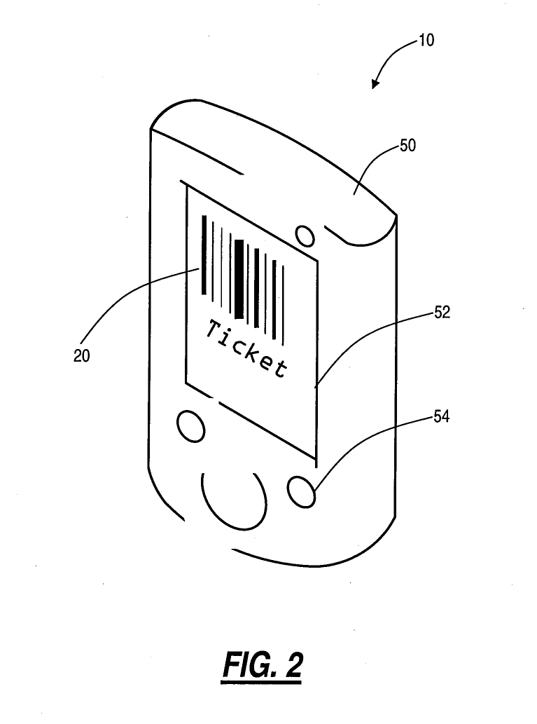

Referring to FIG. 2, in an exemplary embodiment, a perspective view is illustrated of a mobile device 10 with various components for preserving and displaying critical data. The mobile device 10 may include a housing 50, a display screen 52, and an input mechanism 54. For example, the housing 50 may include all of the various components described in FIG. 1. Additionally, the housing 50 includes the display screen 52 and the input mechanism 54. Note, in this exemplary embodiment, the display screen 52 includes the E-ink display 20 as an overlay. Alternatively, the mobile device 10 may include a separate display for the E-ink display 20 on the housing 50 separate from the display screen 52. The mobile device 10 may include other components not illustrated herein, such as, for example, a battery, an internal antenna, etc.

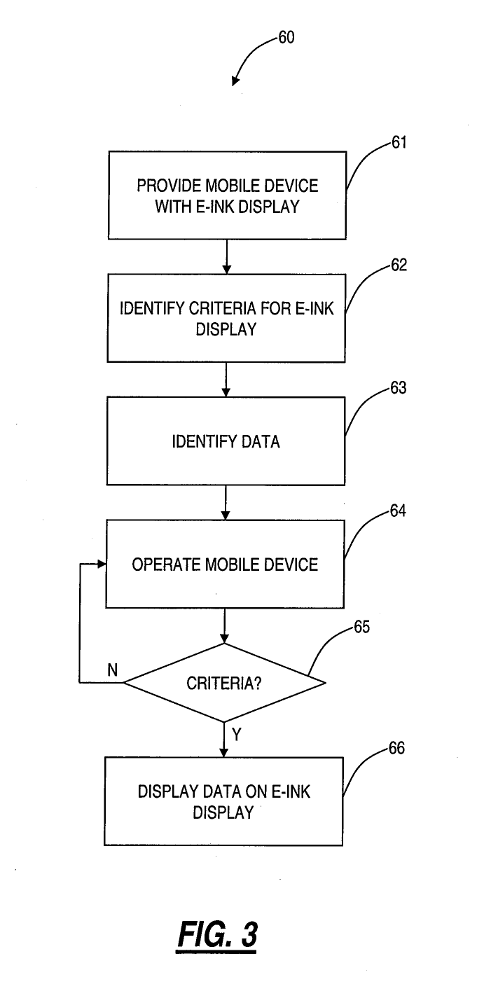

Referring to FIG. 3, in an exemplary embodiment, a flowchart illustrates a method 60 for preserving and displaying critical data with a mobile device. The method 60 may be implemented on any mobile device with an electronic ink or paper display, such as the mobile device 10 (step 61). Various criteria are identified for when the E-ink display is activated (step 62). Example criteria may include loss of power, low battery power, user-defined events, specific date/time, manual trigger by a user, and the like. The data for display on the E-ink display is identified (step 63). As described herein, the data may be identified by the user or automatically by the mobile device. Example data may include ticketing information, barcode, owner information, map/directions, emails, user-defined text, and the like. After identifying the criteria and the information, the user may operate the mobile device (step 64). If the criteria does not occur (step 65), the user may continue to operate the mobile device. If the criteria does occur (step 66), the data is displayed on the E-ink display (step 65).

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A mobile device, comprising:
memory;
input/output interfaces;
a processor;
an electronic ink display; and
an interface communicatively coupling the memory, the input/output interfaces, the processor, and the electronic ink display;
wherein the electronic ink display is configured to display data responsive to predetermined criteria.

2. The mobile device of claim 1, further comprising:
a wireless network interface communicatively coupled to the memory, the input/output interfaces, the processor, and the electronic ink display through the interface.

3. The mobile device of claim 2, further comprising:
a housing in which each of the wireless network interface, the memory, the input/output interfaces, the processor, and the electronic ink display are disposed.

4. The mobile device of claim 3, wherein the electronic ink display is disposed on the housing separate from a display associated with the input/output interfaces.

5. The mobile device of claim 3, wherein the electronic ink display is disposed on the housing separate overlaid on a display associated with the input/output interfaces.

6. The mobile device of claim 1, wherein the data comprises one of a reference code number and a location code number.

7. The mobile device of claim 1, wherein the data comprises a scan-able code.

8. The mobile device of claim 7, wherein the scan-able code comprises a bar code associated with ticketing.

9. The mobile device of claim 1, wherein the data comprises a map or directions.

10. The mobile device of claim 1, wherein the processor is configured to:
receive input from a user;
identify data for display on the electronic ink display;
determine an occurrence of the predetermined criteria; and
direct the electronic ink display to display the data based on the occurrence.

11. The mobile device of claim 10, wherein the predetermined criteria comprise at least one of loss of power for the mobile device, low battery, and a user-defined occurrence.

12. The mobile device of claim 1, wherein the processor is configured to:
receive owner information from a user;
responsive to turning the mobile device off, display the owner information on the electronic ink display.

13. The mobile device of claim 1, wherein the processor is configured to:
responsive to low battery, turn off the mobile device;
provide a user interface through the electronic ink display; and
provide limited access to the memory through the electronic ink display.

14. The mobile device of claim 1, wherein the processor is configured to:
provide a graphical user interface to a user;
identify data through the graphical user interface for display on the electronic ink display;
identify through the graphical user interface the predetermined criteria for displaying the data on the electronic ink display;
determine an occurrence of the predetermined criteria; and
direct the electronic ink display to display the data based on the occurrence.

15. The mobile device of claim 1, wherein the electronic ink display comprises any of Gyricon, electrophoretic, Electro-wetting, Electrofluidic, cholesteric liquid crystal, Nemoptic and Nematic materials.

16. An electronic display on a mobile device, comprising:
a low power electronic ink display disposed on a housing of the mobile device; and
an activation mechanism coupled to the low power electronic ink display for displaying predetermined data on the low power electronic ink display upon an occurrence of predetermined criteria.

17. A method, comprising:
providing a device with a low-power electronic display;
identifying critical data;
operating the device; and
responsive to an occurrence of a criteria event, displaying the critical data on the low-power electronic display.

18. The method of claim 17, wherein the device comprises a mobile device and the low-power electronic display comprises one of electronic ink or electronic paper configured to operate when the mobile device has low battery power.

19. The method of claim 17, further comprising:
responsive to powering off the device, displaying owner information identifying the owner of the device on the low-power electronic display.
